(19) United States
(12) Patent Application Publication
(10) Pub. No.: US 2021/0399331 A1
(43) Pub. Date: Dec. 23, 2021

(54) Hybrid Electrolyte For Lithium Metal Battery

(71) Applicant: THE REGENTS OF THE UNIVERSITY OF MICHIGAN, ANN ARBOR, MI (US)

(72) Inventors: JEFFREY SAKAMOTO, ANN ARBOR, MI (US); ARUSHI GUPTA, ANN ARBOR, MI (US)

(21) Appl. No.: 17/351,735

(22) Filed: Jun. 18, 2021

Related U.S. Application Data
(60) Provisional application No. 63/041,258, filed on Jun. 19, 2020.

(51) Int. Cl. H01M 10/056; H01M 10/0525

(52) U.S. Cl. CPC H01M 10/056; H01M 10/0525; H01M 2300/0028; H01M 2300/0071; H01M 2300/0091

(57) ABSTRACT

A hybrid electrolyte for an electrochemical device comprises: (i) a first electrolyte comprising a solid state electrolyte material, such as lithium lanthanum zirconium tantalum oxide (LLZTO) or lithium lanthanum zirconium oxide (LLZO); and a second electrolyte comprising a liquid electrolyte or a gel electrolyte, the second electrolyte comprising a solvent and a salt in case of a liquid electrolyte and polymer, solvent and a salt in case of a gel electrolyte. The salt is selected from the group consisting of lithium (halosulfonyl)imides, lithium (haloalkanesulfonyl)imides, lithium (halosulfonyl haloalkanesulfonyl)imides, and mixtures thereof, wherein the second electrolyte contacts the first surface of the first electrolyte. An electrochemical device comprises the hybrid electrolyte; a cathode facing the first surface of the first electrolyte of the hybrid electrolyte; and an anode contacting the second surface of the first electrolyte of the hybrid electrolyte, wherein the anode comprises lithium metal.

### CROSS-REFERENCES To RELATED APPLICATIONS

This application claims priority to U.S. Patent Application No. 63/041,258 filed Jun. 19, 2020.

### STATEMENT REGARDING FEDERALLY SPONSORED RESEARCH

This invention was made with government support under ARPA-E/F041977 awarded by the Department of Energy. The government has certain rights in the invention.

### FIELD OF THE INVENTION

This invention relates to electrochemical devices, such as lithium batteries, and electrolytes that can be used in a lithium battery.

### BACKGROUND

High energy density battery technology can be achieved by replacing graphitic anodes (600 Wh/I) with lithium metal anodes (>1000 Wh/I) [Ref. 2]. The state-of-the-art (SOA) liquid electrolytes used with graphitic anodes are generally composed of LiPF₆ salt dissolved in a combination of organic solvents. However, when implemented with lithium metal anodes the SOA liquid electrolytes form an unstable solid electrolyte interphase (SEI) leading to cycling instabilities and safety issues. Fast-ion conducting lithium lanthanum zirconium tantalum oxide (LLZTO) electrolyte has emerged as a promising alternative to SOA liquid electrolytes, providing low interfacial resistance (R_{interface}) and improved stability with lithium metal. However, the implementation of LLZTO solid electrolyte in all solid-state batteries would give rise to high resistance solid-solid interfaces in the composite cathodes and at the cathode/solid electrolyte interface. These resistive interfaces cause rapid capacity fade due to chemical instabilities, contact loss and uncompensated volumetric changes in the cathode.

The use of SOA liquid electrolyte between LLZTO and cathode, a hybrid electrolyte, has been suggested as a viable approach where LLZTO protects the lithium metal and liquid electrolyte (LE) eliminates the challenges at the LLZTO/cathode interface. This is a plausible approach, however, there are studies which have reported that the LLZTO reacts with SOA liquid electrolyte to form a solid liquid electrolyte interphase (SLEI) with a high resistance (>100 Ohms·cm²). The results in this disclosure also indicate that Li salt LiPF₆ in SOA liquid electrolyte reacts with LLZTO which leads to increased solid electrolyte/liquid electrolyte (SE/LE) interfacial resistance (R_{interface}). Electrochemical Impedance Spectroscopy (EIS) data shows the increase in interfacial resistance from 407 Ohm·cm² to 830 Ohms·cm² in 24 hours (FIG. 2). Not only does the high resistance lead to significant overpotentials, the incompatibility can also cause cycling instabilities. From the outcomes of these studies, it was clear that instability between LLZTO/liquid electrolyte has to be overcome for the successful implementation of the solid electrolyte/liquid electrolyte hybrid electrolyte approach.

What is needed therefore are compositions and methods for the formation of a stable solid electrolyte/liquid electrolyte interface for the successful implementation of hybrid electrolyte schemes to enable lithium metal anodes.

### SUMMARY OF THE INVENTION

The present disclosure provides a lithium metal battery with a hybrid electrolyte comprising a liquid electrolyte or a gel electrolyte and a solid state electrolyte, where the solid state electrolyte protects the lithium metal anode and the liquid electrolyte or the gel electrolyte improves the lithium ion transport between the cathode and the solid state electrolyte.

In one aspect, the present disclosure provides a hybrid electrolyte for an electrochemical device, the hybrid electrolyte comprising:
(i) a first electrolyte having a first surface and an opposed second surface, the first electrolyte comprising a solid state electrolyte material having the formula LiᵤReᵥM_{w}AₓO_{y}, wherein
   Re can be any combination of elements with a nominal valance of +3 including La, Nd, Pr, Pm, Sm, Sc, Eu, Gd, Tb, Dy, Y, Ho, Er, Tm, Yb, and Lu;
   M can be any combination of metals with a nominal valance of +3, +4, +5 or +6 including Zr, Ta, Nb, Sb, W, Hf, Sn, Ti, V, Bi, Ge, and Si;
   A can be any combination of dopant atoms with nominal valance of +1, +2, +3 or +4 including H, Na, K, Rb, Cs, Ba, Sr, Ca, Mg, Fe, Co, Ni, Cu, Zn, Ga, Al, B, and Mn;
   u can vary from 3-7.5;
   v can vary from 0-3;
   w can vary from 0-2;
   x can vary from 0-2; and
   y can vary from 11-12.5; and
(ii) a second electrolyte comprising a liquid electrolyte or a gel electrolyte, the second electrolyte comprising a solvent and a lithium salt selected from the group consisting of lithium (halosulfonyl)imides, lithium (haloalkanesulfonyl)imides, lithium (halosulfonyl haloalkanesulfonyl)imides, and mixtures thereof,
wherein the second electrolyte contacts the first surface of the first electrolyte.

In one non-limiting example embodiment, the solid state electrolyte material is Li_{6.5}La₃Zr_{1.5}Ta_{0.5}O₁₂ (LLZTO).

In one non-limiting example embodiment, the solid state electrolyte material is Li₇La₃Zr₂O₁₂ (LLZO).

In one non-limiting example embodiment, the solid state electrolyte material has a garnet phase.

In the hybrid electrolyte, the salt can be selected from lithium bis(fluorosulfonyl)imide (LiFSI), lithium bis(trifluoromethanesulfonyl)imide (LiTFSI), lithium (fluorosulfonyl trifluoromethanesulfonyl)imide (LiFTFSI), and lithium bis(pentafluoroethanesulfonyl)imide (LiBETI). In one non-limiting example embodiment, the salt is lithium bis(trifluoromethanesulfonyl)imide (LiTFSI).

In the hybrid electrolyte, the solvent may be selected from the group consisting of acetonitrile, propylene carbonate, dimethyl carbonate, dimethoxy ethane, dioxolane, ethylene carbonate, ethylmethyl carbonate, diethyl carbonate, dimethyl sulfoxide, diethyl carbonate, fluoroethylene carbonate, vinylene carbonate, and mixtures thereof.

In one non-limiting example embodiment, the second electrolyte is a liquid electrolyte. The liquid electrolyte can have a concentration in a range of 0.1 molal to 22 molal. The liquid electrolyte can have a molar concentration in a range of 2 M to 4 M.

In one non-limiting example embodiment, the salt is lithium bis(trifluoromethanesulfonyl)imide (LiTFSI), and the solvent is selected from the group consisting of acetonitrile, propylene carbonate, dimethyl carbonate, dimethoxy ethane, dioxolane, ethylene carbonate, ethylmethyl carbonate, diethyl carbonate, dimethyl sulfoxide, diethyl carbonate, fluoroethylene carbonate, vinylene carbonate, and mixtures thereof.

In one non-limiting example embodiment, the second electrolyte is a gel electrolyte. The gel electrolyte can comprise a polymer selected from the group consisting of polyethylene oxide (PEO) based polymers, polyvinylidene fluoride (PVDF) based polymers, polyacrylonitrile (PAN) based polymers, polymethyl methacrylate (PMMA) based polymers, poly(vinyl) chloride (PVC) based polymers, and mixtures thereof; and a salt selected from lithium bis(fluorosulfonyl)imide (LiFSI), lithium bis(trifluoromethanesulfonyl)imide (LiTFSI), lithium (fluorosulfonyl trifluoromethanesulfonyl)imide (LiFTFSI), and lithium bis(pentafluoroethanesulfonyl)imide (LiBETI); and a solvent selected from the group consisting of acetonitrile, propylene carbonate, dimethyl carbonate, dimethoxy ethane, dioxolane, ethylene carbonate, ethylmethyl carbonate, diethyl carbonate, dimethyl sulfoxide, diethyl carbonate, fluoroethylene carbonate, vinylene carbonate, and mixtures thereof. In one non-limiting example embodiment, the polymer comprises poly(vinylidene flouride-co-hexafluoropropylene) (PVDF-HFP), and the salt is lithium bis(trifluoromethanesulfonyl)imide (LiTFSI). In one non-limiting example embodiment, the polymer comprises polyacrylonitrile (PAN), and the salt is lithium bis(trifluoromethanesulfonyl)imide (LiTFSI).

The solid state electrolyte material of the hybrid electrolyte can be densified through conventional sintering or hot pressed. The solid state electrolyte material of the hybrid electrolyte can be heat-treated under inert atmosphere to remove surface impurities. The solid state electrolyte material of the hybrid electrolyte can be heat-treated in a temperature range of 350° C. to 700° C. The solid state electrolyte material of the hybrid electrolyte can be heat-treated in a temperature range of 375° C. to 425° C.

In one non-limiting example embodiment of the hybrid electrolyte, the solid state electrolyte material is Li_{6.5}La₃Zr_{1.5}Ta_{0.5}O₁₂ (LLZTO), the salt is lithium bis(trifluoromethanesulfonyl)imide (LiTFSI), and the solvent is propylene carbonate.

In another aspect, the present disclosure provides an electrochemical device comprising: the hybrid electrolyte of the present disclosure; a cathode (with the second electrolyte) facing the first surface of the first electrolyte (i.e., the solid state electrolyte); and an anode contacting the second surface of the first electrolyte (i.e., the solid state electrolyte) of the hybrid electrolyte, wherein the anode comprises lithium metal.

In the electrochemical device, the cathode can comprise a cathode active material selected from lithium metal oxides wherein the metal is one or more aluminum, cobalt, iron, manganese, nickel and vanadium. In the electrochemical device, the cathode can comprise a cathode active material selected from lithium-containing phosphates having a general formula LiMPO₄ wherein M is one or more of cobalt, iron, manganese, and nickel. In the electrochemical device, the cathode can comprise a cathode active material having a formula LiNiₓMn_{y}Co_{z}O₂, wherein x+y+z=1 and x:y:z=1:1:1 (NMC 111), x:y:z=4:3:3 (NMC 433), x:y:z=5:2:2 (NMC 522), x:y:z=5:3:2 (NMC 532), x:y:z=6:2:2 (NMC 622), or x:y:z=8:1:1 (NMC 811).

In one non-limiting example embodiment of the electrochemical device, an interfacial resistance of an interface of the first electrolyte and the second electrolyte is 100 Ohms·cm² or less. In one non-limiting example embodiment of the electrochemical device, an interfacial resistance of an interface of the first electrolyte and the second electrolyte is 60 Ohms·cm² or less. In one non-limiting example embodiment of the electrochemical device, an interfacial resistance of an interface of the first electrolyte and the second electrolyte is 30 Ohms·cm² or less.

In one non-limiting example embodiment of the electrochemical device, the electrochemical device has greater than 95% utilization upon cycling. In one non-limiting example embodiment of the electrochemical device, the electrochemical device has greater than 99% utilization upon cycling.

In one non-limiting example embodiment of the electrochemical device, the electrochemical device has greater than 95% capacity retention over 10 cycles.

The foregoing and other aspects and advantages of the invention will appear from the following description. In the description, reference is made to the accompanying drawings which form a part hereof, and in which there is shown by way of illustration example embodiments of the invention. Such embodiments do not necessarily represent the full scope of the invention, however, and reference is made therefore to the claims and herein for interpreting the scope of the invention.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a schematic of a lithium metal battery.

FIG. 2 shows in a), EIS of a graphite foil/SOA LE/LLZTO/SOA LE/graphite foil cell; in b), R_{interface} increasing with time from 407 to 830 Ohms·cm² in 24 hours; and in c), SEM image of LLZTO exposed to liquid electrolyte showing surface growth and degradation.

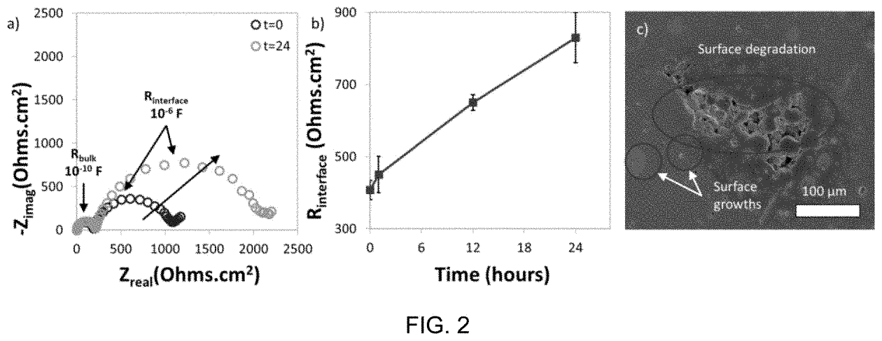

FIG. 3 shows in a), Nyquist plots showing the LLZTO/LE R_{interface} in an H-cell configuration (graphite foil/LE/LLZTO/LE/graphite foil) for three different salt compositions after 48 hours of assembly; and in b) & c), LLZTO-LE R_{interface} measured with time for 0.2M LE for three different salts, LiPF₆, LiTFSI and LiBOB in acetonitrile (ACN). n=3 for each Li salt.

FIG. 4 shows in a), LLZTO-LE R_{interface} measured with time for different LiTFSI concentration in liquid electrolyte: n=3 for each molarity; and in b), LLZTO-LE R_{interface} measured with time over a period of 7 days for a 3M LiTFSI in ACN.

FIG. 5 shows in a), schematic of a Swagelok cell for full cell cycling; in b), EIS plots of a full cell after 1st and 10th cycle step; and in c), voltage profile of a cell with capacity for three cycles.

The invention will be better understood and features, aspects and advantages other than those set forth above will become apparent when consideration is given to the following detailed description thereof. Such detailed description makes reference to the drawings.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. Skilled artisans will recognize the examples provided herein have many useful alternatives and fall within the scope of embodiments of the invention.

Although the systems and methods introduced herein are often described for use in an electrochemical cell or battery, one of skill in the art will appreciate that these teachings can be used for various applications (e.g. sensors, fuel cells).

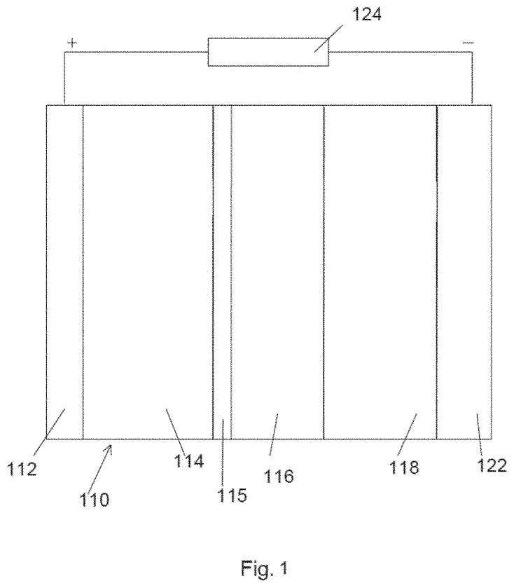

In one non-limiting example application, a hybrid electrolyte of the present disclosure can be used in a lithium metal battery 110 as depicted in FIG. 1. The lithium metal battery 110 includes a current collector 112 (e.g., aluminum) in contact with a cathode 114. The solid-state electrolyte 116 is arranged between the cathode 114 and an anode 118, which is in contact with a current collector 122 (e.g., copper). The current collectors 112 and 122 of the lithium metal battery 110 may be in electrical communication with an electrical component 124. The electrical component 124 could place the lithium metal battery 110 in electrical communication with an electrical load that discharges the battery or a charger that charges the battery. Optionally, a separator 115 may be positioned between the solid-state electrolyte 116 and the cathode 114.

The hybrid electrolyte of the battery 110 can comprise the solid-state electrolyte 116 and a liquid electrolyte. The liquid electrolyte may comprise a lithium salt in an organic solvent. The lithium salt may be selected from LiBF₄, LiClO₄, LiCF₃SO₃ (LiTf), lithium bis(fluorosulfonyl)imide (LiFSI), lithium bis(trifluoromethanesulfonyl)imide (LiTFSI), lithium (fluorosulfonyl trifluoromethanesulfonyl)imide (LiFTFSI),and lithium bis(pentafluoroethanesulfonyl)imide (LiBETI). The organic solvent may be selected from carbonate based solvents, ether based solvents, nitrile solvents, ionic liquids, and mixtures thereof. The solvent may be selected from the group consisting of acetonitrile, propylene carbonate, dimethyl carbonate, dimethoxy ethane, dioxolane, ethylene carbonate, ethylmethyl carbonate, diethyl carbonate, dimethyl sulfoxide, diethyl carbonate, fluoroethylene carbonate, vinylene carbonate, and mixtures thereof. The liquid electrolyte can have a concentration in a range of 0.1 molal to 22 molal. The liquid electrolyte can have a molar concentration in a range of 0.1 M to 4 M. The liquid electrolyte can have a molar concentration in a range of 2 M to 4 M.

The hybrid electrolyte of the battery 110 can comprise the solid-state electrolyte 116 and a gel electrolyte. A gel electrolyte having lithium ion conductivity can be obtained by, for example, adding a polymer to any of the liquid electrolytes described above to form a gel. In particular, a gel can be formed by adding a polymer such as polyethylene oxide (PEO) based polymers, polyvinylidene fluoride (PVDF) based polymers, polyacrylonitrile (PAN) based polymers, polymethyl methacrylate (PMMA) based polymers, poly(vinyl) chloride (PVC) based polymers and mixtures thereof to the liquid electrolyte.

In some embodiments, the solid state electrolyte 116 can comprise a solid state electrolyte material having the formula LiᵤReᵥM_{w}AₓO_{y}, wherein
Re can be any combination of elements with a nominal valance of +3 including La, Nd, Pr, Pm, Sm, Sc, Eu, Gd, Tb, Dy, Y, Ho, Er, Tm, Yb, and Lu;
M can be any combination of metals with a nominal valance of +3, +4, +5 or +6 including Zr, Ta, Nb, Sb, W, Hf, Sn, Ti, V, Bi, Ge, and Si;
A can be any combination of dopant atoms with nominal valance of +1, +2, +3 or +4 including H, Na, K, Rb, Cs, Ba, Sr, Ca, Mg, Fe, Co, Ni, Cu, Zn, Ga, Al, B, and Mn;
u can vary from 3-7.5;
v can vary from 0-3;
w can vary from 0-2;
x can vary from 0-2; and
y can vary from 11-12.5.

The solid state electrolyte material can have the garnet phase. Li_{6.5}La₃Zr_{1.5}Ta_{0.5}O₁₂ (LLZTO) is one non-limiting example solid state electrolyte material. Li₇La₃Zr₂O₁₂ (LLZO) is another non-limiting example solid state electrolyte material.

The solid-state electrolyte 116 may be formed by (a) casting a slurry of a solid-state electrolyte material on a surface to form a layer; and (b) sintering the layer to form the solid-state electrolyte. In this method, the layer may be sintered at a temperature in a range of 600° C. to 1250° C. to achieve the necessary electrochemical properties. The layer can have a thickness in a range of 10 to 200 microns. The solid state electrolyte material can also be heat-treated under inert atmosphere to remove surface impurities. The solid state electrolyte material can be heat-treated in a temperature range of 350° C. to 700° C., or in a temperature range of 375° C. to 425° C.

The solid-state electrolyte 116 may alternatively be formed by a hot pressing technique comprising combining dry powders having the desired cations for the final solid-state electrolyte to form a mixture; cold-pressing and calcining the mixed dry powders at temperatures between 500-1000 degrees Celsius for 2-8 hours; and applying simultaneous heat and pressure to the mixture to form the solid-state electrolyte. The hot-pressing technique may use at least one of induction heating, indirect resistance heating, or direct hot-pressing. Heat can be applied at a temperature at or below 1250 degrees Celsius. Pressure can be applied at between 5 and 80 MPa. The solid state electrolyte material can also be heat-treated under inert atmosphere to remove surface impurities. The solid state electrolyte material can be heat-treated in a temperature range of 350° C. to 700° C., or in a temperature range of 375° C. to 425° C.

A suitable active material for the cathode 114 of the lithium metal battery 110 is a lithium host material capable of storing and subsequently releasing lithium ions. An example cathode active material is a lithium metal oxide wherein the metal is one or more aluminum, cobalt, iron, manganese, nickel and vanadium. Non-limiting example lithium metal oxides are LiCoO₂ (LCO), LiFeO₂, LiMnO₂ (LMO), LiMn₂O₄, LiNiO₂ (LNO), LiNiₓCo_{y}O₂ (x+y=1), LiMnₓCo_{y}O₂ (x+y=1), Li(NiₓMny)O₄ (x+y=1), LiMnₓNi_{y}O₂ (x+y=1), LiMnₓNi_{y}O₄ (x+y=1), LiNiₓCo_{y}Al_{z}O₂(x+y+z=1), LiNi_{1/3}Mn_{1/3}Co_{1/3}O₂ and others. Another example of cathode active materials is a lithium-containing phosphate having a general formula LiMPO₄ wherein M is one or more of cobalt, iron, manganese, and nickel, such as LiFePO₄, LiCoPO₄, Li(CoₓFe_{y}Ni_{z})PO₄ (x+y+z=1), and lithium iron fluorophosphates. Another example of a cathode active material is V₂O₅. Many different elements, e.g., Co, Mn, Ni, Cr, Al, or Li, may be substituted or additionally added into the structure to influence electronic conductivity, ordering of the layer, stability on delithiation and cycling performance of the cathode materials. The cathode active material can be selected from the group consisting of cathode material particles having a formula LiNiₓMn_{y}Co_{z}O₂, wherein x+y+z=1 and x:y:z=1:1:1 (NMC 111), x:y:z=4:3:3 (NMC 433), x:y:z=5:2:2 (NMC 522), x:y:z=5:3:2 (NMC 532), x:y:z=6:2:2 (NMC 622), or x:y:z=8:1:1 (NMC 811). The cathode active material can be a mixture of any number of these cathode active materials. In other embodiments, a suitable material for the cathode 114 of the lithium battery 110 is porous carbon (for a lithium air battery), or a sulfur containing material (for a lithium sulfur battery).

In some embodiments, a suitable active material for the anode 118 of the lithium battery 110 consists of lithium metal. In other embodiments, an example anode 118 material consists essentially of lithium metal.

The first current collector 112 and the second current collector 122 can comprise a conductive metal or any suitable conductive material. In some embodiments, the first current collector 112 and the second current collector 122 comprise aluminum, nickel, copper, combinations and alloys thereof. In other embodiments, the first current collector 112 and the second current collector 122 have a thickness of 0.1 microns or greater. It is to be appreciated that the thicknesses depicted in FIG. 1 are not drawn to scale, and that the thickness of the first current collector 112 and the second current collector 122 may be different.

An example separator 115 material for the lithium metal battery 110 can a permeable polymer such as a polyolefin. Example polyolefins include polyethylene, polypropylene, and combinations thereof. Glass fiber materials are other example separator materials.

An electrochemical device of the invention may comprise: a hybrid electrolyte of the present disclosure; a cathode facing the first surface of the first electrolyte of the hybrid electrolyte; and an anode contacting the second surface of the first electrolyte of the hybrid electrolyte, wherein the anode comprises lithium metal. In the electrochemical device, an interfacial resistance of an interface of the first electrolyte and the second electrolyte can be 100 Ohms·cm² or less, or 90 Ohms·cm² or less, or 80 Ohms·cm² or less, or 70 Ohms·cm² or less, or 60 Ohms·cm² or less, or 50 Ohms·cm² or less, or 40 Ohms·cm² or less, or 30 Ohms·cm² or less, or 20 Ohms·cm² or less, or 10 Ohms·cm² or less. The electrochemical device can have greater than 95% utilization upon cycling between 2.5 V and 4.2 V at a C/20 rate. The electrochemical device can have greater than 98% utilization upon cycling between 2.5 V and 4.2 V at a C/20 rate. The electrochemical device can have greater than 99% utilization upon cycling between 2.5 V and 4.2 V at a C/20 rate. The electrochemical device can have greater than 95% capacity retention over 10 cycles between 2.5 V and 4.2 V at a C/20 rate. The electrochemical device can have greater than 98% capacity retention over 10 cycles between 2.5 V and 4.2 V at a C/20 rate. The electrochemical device can have greater than 99% capacity retention over 10 cycles between 2.5 V and 4.2 V at a C/20 rate.

In this disclosure, we isolated the effects of each liquid electrolyte component to identify the component that reacts with LLZTO. By understanding the reactions between the solid electrolyte (SE) and liquid electrolyte (LE), we developed an approach to limit the chemical side reactions at the interface. It was determined that the chemical reactions and high R_{interface} between the liquid electrolyte and LLZTO were highly sensitive to the lithium salt. Lithium hexafluorophosphate (LiPF6) and lithium bis(oxalato)borate (LiBOB) showed unstable behavior against LLZTO leading to high interface resistance, whereas, lithium bis(trifluoromethanesulfonyl)imide (LiN(CF₃SO₂)₂) (LiTFSI) was shown to be dramatically more stable. Overall, by understanding the reaction pathways between the liquid electrolyte and LLZTO solid electrolyte, we identified a compatible liquid electrolyte solvent/salt combination to achieve stable interfaces exhibiting R_{interface} under 50 Ohms·cm², which is comparable to electrode interfaces in Li-ion battery technology. We further demonstrate preliminary full cell cycling utilizing the hybrid electrolyte approach and lithium metal anodes with minimal capacity fade. Overall, a systematic study was performed to identify, isolate and overcome the chemical instability between LLZTO and conventional liquid electrolytes. The results made it possible to effectively implement the hybrid electrolyte approach to enable lithium metal anodes in a battery.

### EXAMPLES

The following Examples are provided in order to demonstrate and further illustrate certain embodiments and aspects of the present invention and are not to be construed as limiting the scope of the invention. The statements provided in the examples are presented without being bound by theory.

### Example 1

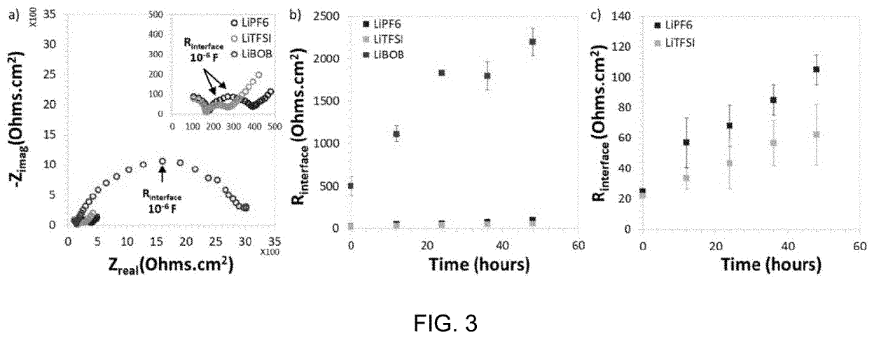

As discussed earlier, the approach we took to overcome the instability between LLZTO and liquid electrolyte was to isolate the effects of each liquid electrolyte component to identify the component that reacts with LLZTO. First, the effect of organic solvents on LLZTO was studied followed by lithium salts. The results indicate that LLZTO does form an interfacial layer in contact with the solvents, however, the effects of it on the electrochemical performance might be benign. To study the effect of Li salt on LLZTO, we evaluated the interactions with three different Li salts namely LiPF₆, LiBOB and LiTFSI. The results indicate that the R_{interface} between LLZTO and 0.2 M LiBOB in acetonitrile (ACN) was unexpectedly high. It was also found that LiPF₆ and LiTFSI initially have relatively low R_{interface} with LLZTO (28 Ohms·cm² and 22 Ohms·cm², respectively). However, the R_{interface} increases with time for all the three salts stabilizing only for LiTFSI (see FIG. 3). The resistance keeps increasing for LiBOB and LiPF₆ and was 20 times larger for LiBOB than with LiPF₆. In contrast, the resistance with LiTFSI seems to stabilize at 55 Ohms·cm². Thus, from the EIS analysis LiTFSI is the most stable against LLZTO.

### Example 2

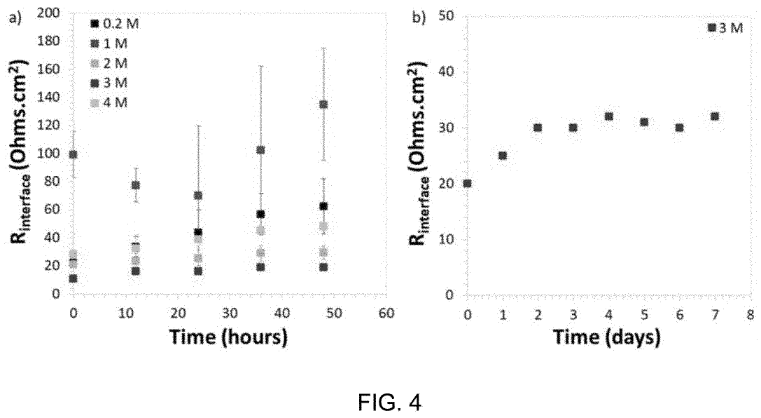

After evaluating the stability of LLZTO with different lithium salts, it was concluded that LLZTO shows a stable behavior with LiTFSI under open circuit conditions. However, the resistance did grow over 48 hours to 55 Ohms·cm². We believe that optimizing the concentration of the LiTFSI salt in the solvent would improve the stability and kinetics of the LLZTO/liquid electrolyte interface due to the stability of liquid electrolyte with lower concentration of solvent, effect on desolvation kinetics, wettability [Ref. 3,4]. The effect of the lithium salt concentration on the LLZTO-liquid electrolyte R_{interface} was studied for 5 different concentrations. Acetonitrile (ACN) was again used as the solvent. From a) in FIG. 4, it was observed that the R_{interface} decreased, from 50 Ohms·cm² (0.2 M LiTFSI) to <30 Ohms·cm² (3 M LiTFSI), with increasing the salt concentration, possibly due to increasing charge carrier concentration and lower free solvent, up to 4 M concentration, which was close to the solubility limit of LiTFSI in ACN. There was an exception at 1 M LiTFSI in ACN (the reason is not well understood) where the R_{interface} was observed to be higher than other concentrations. Another important observation was that higher salt concentrations led to lower and more stable R_{interface}. The lowest R_{interface} of around 20 Ohms·cm² was observed for a 3 M LiTFSI in ACN. The stability of LLZTO with a 3 M LiTFSI in ACN was evaluated for 7 days and it was observed that the R_{interface} stabilizes within the first 2 days of assembly to 28 Ohms·cm². Overall, by systematically studying the effect of various organic solvents and salts, the LLZTO/liquid electrolyte R_{interface} was reduced to 20-35 Ohms·cm² at room temperature for both 2M and 3M LiTFSI in ACN liquid electrolyte (FIG. 4). It is important to remember that for full cells the utilization of a 2 M LiTFSI liquid electrolyte would be beneficial since a higher molarity would lead to increased polarization in the cell and affect the wettability of the cathode. The slight fluctuations in the R_{interface} over time were likely due to the changes in ambient temperature.

### Example 3

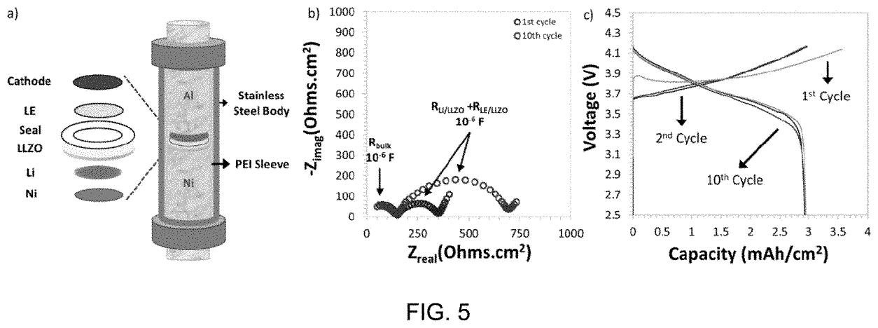

After optimizing and minimizing LLZTO-liquid electrolyte interfacial resistance to practical values (20-30 Ohms·cm²), next we evaluated the stability and performance of the LLZTO/liquid electrolyte interface during cycling. To demonstrate as proof-of-concept, cycling was performed on a full Li/LLZTO/LE-GF/D/NCA cell with the configuration shown in a) of FIG. 5, where NCA is lithium nickel cobalt aluminum oxide and GF/D is a glass fiber filter separator. A Swagelok cell was utilized for the full cell assembly. Since it was shown above that the reactivity of LLZTO with a liquid electrolyte was strongly dependent on salt and concentration of the salt, propylene carbonate (PC) was chosen over ACN as the solvent for full cells due to its low vapor pressure and similar solvation/desolvation kinetics to ACN. The cell was galvanostatically cycled for 10 cycles between 2.5 and 4.2 V versus Li/Li+ at a C/20 rate (0.15 mA/cm² current density). FIG. 5 in b) shows the EIS data for the total cell resistance after the 1st and 10th cycle. The R_{interface} grows by a factor of 2 after 10 cycles. The increase in resistance is likely due to the Li/LLZTO, LLZTO/catholyte or LE/cathode interface. FIG. 5 in c) shows the voltage profile for the 1st, 2nd and the 10th cycle. It was observed from FIG. 5 in c) that there was an overcharge for the 1st cycle, which we commonly observe for NCA cathodes. After the 1st cycle, the utilization of the cathode was approximately 100% with a capacity retention of 98.5% over 10 cycles with minimal overpotentials. Though the overall capacity retention and Coulombic efficiency were high, there was some deviation in the voltage profile at high voltages during a few charge cycles. These deviations observed led to excess capacity for those charge cycles and low Coulombic efficiencies; however, the performance was recovered in consequent cycles. We believe that the deviations in the voltage profile may be related to the stability of the LLZTO/catholyte interface under cycling conditions. From these data, it can be concluded that higher concentration LiTFSI based electrolytes are compatible with LLZTO and could provide a viable route for the successful implementation of hybrid electrolyte systems for a Li metal anode.

Formation of a stable solid electrolyte/liquid electrolyte (SE/LE) interface is essential for the successful implementation of hybrid electrolyte schemes to enable lithium metal anodes. Unfortunately, it has been shown that the promising solid electrolyte lithium lanthanum zirconium tantalum oxide (LLZTO) reacts with LiPF₆-based state-of-the-art liquid electrolyte [Ref. 1]. In this invention, the source of the instability was identified and mitigated. This was achieved by studying and isolating the effects of organic solvent and Li salts present in the liquid electrolyte on LLZTO. The results indicate that Li salt LiPF₆ in SOA liquid electrolyte reacts with LLZTO leading to an increase in SE/LE interfacial resistance (R_{interface}). The R_{interface} increases with time after reacting with LiPF₆ and LiBOB salts to ˜120 and 2000 Ohms·cm² in 48 hours, which is significantly higher than in Li ion batteries (˜10-100 Ohms·cm²). On the contrary, LiTFSI-based Li salt was stable with LLZTO where R_{interface} is ˜55 Ohms·cm². Further optimization of the LiTFSI salt concentration (3M), resulted in an R_{interface} of ˜30 Ohms·cm². We also demonstrated preliminary cycling of Li/LLZTO/LE/NCA cells with ˜100% utilization and 98.5% capacity retention over 10 cycles. Overall, this invention reports a solution that mitigates the LLZTO/LE chemical instability providing a step towards the successful implementation of hybrid electrolytes in lithium metal batteries.

### REFERENCES

(1) Liu, et al., The Interface between Li_{6.5}La₃Zr_{1.5}Ta_{0.5}O₁₂ and Liquid Electrolyte, Joule 4, 101-108, 2020. https://doi.org/10.1016/j.joule.2019.10.001.

(2) Van Noorden, R.; Richard Van Noorden. A Better Battery. Nature 2014, 507 (7490), 26-28. https://doi.org/10.1038/507026a.

(3) Busche, M. R.; Drossel, T.; Leichtweiss, T.; Weber, D. A.; Falk, M.; Schneider, M.; Reich, M. L.; Sommer, H.; Adelhelm, P.; Janek, J. Dynamic Formation of a Solid-Liquid Electrolyte Interphase and Its Consequences for Hybrid-Battery Concepts. Nat. Chem. 2016, 8 (5), 426-434. https://doi.org/10.1038/nchem.2470.

(4) Lundgren, H.; Scheers, J.; Behm, M.; Lindbergh, G., Characterization of the Mass-Transport Phenomena in a Superconcentrated LiTFSI: Acetonitrile Electrolyte. J. Electrochem. Soc. 2015, 162 (7), A1334-A1340. https://doi.org/10.1149/2.0961507jes.

The citation of any document is not to be construed as an admission that it is prior art with respect to the present invention.

Thus, the present invention provides electrochemical devices, such as lithium batteries, and electrolytes that can be used in a lithium battery.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein. Various features and advantages of the invention are set forth in the following claims.

What is claimed is:

1. A hybrid electrolyte for an electrochemical device, the hybrid electrolyte comprising:
(i) a first electrolyte having a first surface and an opposed second surface, the first electrolyte comprising a solid state electrolyte material having the formula LiᵤReᵥM_{w}AₓO_{y}, wherein
Re can be any combination of elements with a nominal valance of +3 including La, Nd, Pr, Pm, Sm, Sc, Eu, Gd, Tb, Dy, Y, Ho, Er, Tm, Yb, and Lu;
M can be any combination of metals with a nominal valance of +3, +4, +5 or +6 including Zr, Ta, Nb, Sb, W, Hf, Sn, Ti, V, Bi, Ge, and Si;
A can be any combination of dopant atoms with nominal valance of +1, +2, +3 or +4 including H, Na, K, Rb, Cs, Ba, Sr, Ca, Mg, Fe, Co, Ni, Cu, Zn, Ga, Al, B, and Mn;
u can vary from 3-7.5;
v can vary from 0-3;
w can vary from 0-2;
x can vary from 0-2; and
y can vary from 11-12.5; and
(ii) a second electrolyte comprising a liquid electrolyte or a gel electrolyte, the second electrolyte comprising a solvent and a salt selected from the group consisting of lithium (halosulfonyl)imides, lithium (haloalkanesulfonyl)imides, lithium (halosulfonyl haloalkanesulfonyl)imides, and mixtures thereof,
wherein the second electrolyte contacts the first surface of the first electrolyte.

2. The hybrid electrolyte of claim 1 wherein:
the solid state electrolyte material is Li_{6.5}La₃Zr_{1.5}Ta_{0.5}O₁₂ (LLZTO).

3. The hybrid electrolyte of claim 1 wherein:
the solid state electrolyte material is Li₇La₃Zr₂O₁₂ (LLZO).

4. The hybrid electrolyte of claim 1 wherein:
the salt is selected from lithium bis(fluorosulfonyl)imide (LiFSI), lithium bis(trifluoromethanesulfonyl)imide (LiTFSI), lithium (fluorosulfonyl trifluoromethanesulfonyl)imide (LiFTFSI), and lithium bis(pentafluoroethanesulfonyl)imide (LiBETI).

5. The hybrid electrolyte of claim 1 wherein:
the salt is lithium bis(trifluoromethanesulfonyl)imide (LiTFSI).

6. The hybrid electrolyte of claim 1 wherein:
the solvent is selected from the group consisting of acetonitrile, propylene carbonate, dimethyl carbonate, dimethoxy ethane, dioxolane, ethylene carbonate, ethylmethyl carbonate, diethyl carbonate, dimethyl sulfoxide, diethyl carbonate, fluoroethylene carbonate, vinylene carbonate, and mixtures thereof.

7. The hybrid electrolyte of claim 1 wherein:
the second electrolyte is a liquid electrolyte.

8. The hybrid electrolyte of claim 7 wherein:
the liquid electrolyte has a concentration in a range of 0.1 molal to 22 molal.

9. The hybrid electrolyte of claim 7 wherein:
the liquid electrolyte has a molar concentration in a range of 2 M to 4 M.

10. The hybrid electrolyte of claim 7 wherein:
the salt is lithium bis(trifluoromethanesulfonyl)imide (LiTFSI), and
the solvent is selected from the group consisting of acetonitrile, propylene carbonate, dimethyl carbonate, dimethoxy ethane, dioxolane, ethylene carbonate, ethylmethyl carbonate, diethyl carbonate, dimethyl sulfoxide, diethyl carbonate, fluoroethylene carbonate, vinylene carbonate, and mixtures thereof.

11. The hybrid electrolyte of claim 1 wherein:
the second electrolyte is a gel electrolyte.

12. The hybrid electrolyte of claim 11 wherein:
the gel electrolyte comprises a polymer selected from the group consisting of polyethylene oxide (PEO) based polymers, polyvinylidene fluoride (PVDF) based polymers, polyacrylonitrile (PAN) based polymers, polymethyl methacrylate (PMMA) based polymers, poly(vinyl) chloride (PVC) based polymers, and mixtures thereof.

13. The hybrid electrolyte of claim 11 wherein:
the solvent is selected from the group consisting of acetonitrile, propylene carbonate, dimethyl carbonate, dimethoxy ethane, dioxolane, ethylene carbonate, ethylmethyl carbonate, diethyl carbonate, dimethyl sulfoxide, diethyl carbonate, fluoroethylene carbonate, vinylene carbonate, and mixtures thereof.

14. The hybrid electrolyte of claim 12 wherein:
the polymer comprises poly(vinylidene flouride-co-hexafluoropropylene) (PVDF-HFP), and the salt is lithium bis(trifluoromethanesulfonyl)imide (LiTFSI).

15. The hybrid electrolyte of claim 12 wherein:
the polymer comprises polyacrylonitrile (PAN), and
the salt is lithium bis(trifluoromethanesulfonyl)imide (LiTFSI).

16. The hybrid electrolyte of claim 1 wherein:
the solid state electrolyte material is densified through conventional sintering or hot pressed.

17. The hybrid electrolyte of claim 1 wherein:
the solid state electrolyte material is heat-treated under inert atmosphere to remove surface impurities.

18. The hybrid electrolyte of claim 17 wherein:
the solid state electrolyte material is heat-treated in a temperature range of 350° C. to 700° C.

19. The hybrid electrolyte of claim 17 wherein:
the solid state electrolyte material is heat-treated in a temperature range of 375° C. to 425° C.

20. The hybrid electrolyte of claim 1 wherein:
the solid state electrolyte material is Li_{6.5}La₃Zr_{1.5}Ta_{0.5}O₁₂ (LLZTO),
the salt is lithium bis(trifluoromethanesulfonyl)imide (LiTFSI), and
the solvent is propylene carbonate.

21. The hybrid electrolyte of claim 1 wherein:
the solid state electrolyte material has a garnet phase.

22. An electrochemical device comprising:
the hybrid electrolyte of claim 1;
a cathode facing the first surface of the first electrolyte of the hybrid electrolyte; and
an anode contacting the second surface of the first electrolyte of the hybrid electrolyte, wherein the anode comprises lithium metal.

23. The electrochemical device of claim 22 wherein:
the cathode comprises a cathode active material selected from lithium metal oxides wherein the metal is one or more aluminum, cobalt, iron, manganese, nickel and vanadium.

24. The electrochemical device of claim 22 wherein:
the cathode comprises a cathode active material selected from lithium-containing phosphates having a general formula LiMPO₄ wherein M is one or more of cobalt, iron, manganese, and nickel.

25. The electrochemical device of claim 22 wherein:
the cathode comprises a cathode active material having a formula LiNiₓMn_{y}Co_{z}O₂, wherein x+y+z=1 and x:y:z=1:1:1 (NMC 111), x:y:z=4:3:3 (NMC 433), x:y:z=5:2:2 (NMC 522), x:y:z=5:3:2 (NMC 532), x:y:z=6:2:2 (NMC 622), or x:y:z=8:1:1 (NMC 811).

26. The electrochemical device of claim 22 wherein:
an interfacial resistance of an interface of the first electrolyte and the second electrolyte is 100 Ohms·cm² or less.

27. The electrochemical device of claim 22 wherein:
an interfacial resistance of an interface of the first electrolyte and the second electrolyte is 60 Ohms·cm² or less.

28. The electrochemical device of claim 22 wherein:
an interfacial resistance of an interface of the first electrolyte and the second electrolyte is 30 Ohms·cm² or less.

29. The electrochemical device of claim 22 wherein:
the electrochemical device has greater than 95% utilization upon cycling.

30. The electrochemical device of claim 22 wherein:
the electrochemical device has greater than 99% utilization upon cycling.

31. The electrochemical device of claim 22 wherein:
the electrochemical device has greater than 95% capacity retention over 10 cycles.
